(19) United States
(12) Patent Application Publication
(10) Pub. No.: US 2003/0126589 A1
(43) Pub. Date: Jul. 3, 2003

(54) Providing parallel computing reduction operations

(76) Inventors: David K. Poulsen, Champaign, IL (US); Sanjiv M. Shah, Champaign, IL (US); Paul M. Petersen, Champaign, IL (US); Grant E. Haab, Mahomet, IL (US); Jay P. Hoeflinger, Urbana, IL (US)

Correspondence Address: Timothy N. Trop, TROP, PRUNER & HU, P.C., STE 100, 8554 KATY FWY, HOUSTON, TX, 77024-1805, US

(21) Appl. No.: 10/039,789

(22) Filed: Jan. 2, 2002

(51) Int. Cl. G06F 9/45; G06F 15/00

(52) U.S. Cl. 717/149; 712/23

(57) ABSTRACT

A method and apparatus for a reduction operation is described. A method may be utilized that includes receiving a first program unit in a parallel computing environment, the first program unit may include a reduction operation to be performed and translating the first program unit into a second program unit, the second program unit may associate the reduction operation with a set of one or more low-level instructions that may, in part, perform the reduction operation.

### FIELD OF THE INVENTION

The invention relates to the field of computer processing and more specifically to a method and apparatus for parallel computation.

### BACKGROUND

In order to achieve high performance execution of difficult and complex programs, scientists, engineers, and independent software vendors have turned to parallel processing computers and applications. Parallel processing computers typically use multiple processors to execute programs in a parallel fashion that typically produces results faster than if the programs were executed on a single processor. Each parallel execution process is often referred to as a “thread”. Each thread may execute on a different processor. However, multiple threads may also execute on a single processor. A parallel computing system may be a collection of multiple processors in a clustered arrangement in some embodiments. In other embodiments, it may be a distributed-memory system or a shared memory processor system (“SMP”). Other parallel computing architectures are also possible.

In order to focus industry research and development, a number of companies and groups have banded together to form industry-sponsored consortiums to advance or promote certain standards relating to parallel processing. The Open Multi-Processing (“OpenMP”) standard is one such standard that has been developed.

This specification may include a number of directives that indicate to a compiler how particular code structures should be compiled. The designers of the compiler determine the manner in which these directives are compiled by a compiler meeting the OpenMP specification. Often, these directives are implemented with low-level assembly or object code that may be designed to run on a specific computing platform. This may result in considerable programming effort being expended to support a particular directive across a number of computing platforms. As the number of computing platforms expands, the costs to produce the low-level instructions may become considerable.

Additionally, there exists a need for extending the OpenMP standard to allow for additional code structures to handle time consuming tasks such as reduction functions. A reduction function is an operation wherein multiple threads may collaborate to perform an accumulation type operation often faster than a single thread may perform the same operation.

The OpenMP standard may specify methods for performing reductions that may have been utilized in legacy code. For example, reductions may be performed utilizing, the “!$OMP Critical”/“!$OMP End Critical directives. However these directives may not scale well when more than a small number of threads are utilized. In addition, the critical sections of code are often implemented using software locks. The use of locks may cause contention between multiple processors as each attempt to acquire a lock on a memory area at the same time.

What is needed therefore is a method and apparatus that may implement reduction operations that may be efficient and cost effectively implemented over multiple computer platforms and may convert a legacy code structure to a form that may be more efficiently executed.

### BRIEF DESCRIPTION OF THE DRAWINGS

The invention may best be understood by referring to the following description and accompanying drawings that are used to illustrate embodiments of the invention. In the drawings:

FIG. 1 is a schematic depiction of a processor-based system in accordance with one embodiment of the present invention.

FIG. 2 illustrates a data flow diagram for the generation of executable code according to embodiments of the present invention.

FIG. 3 is a flow chart for the generation of a number of program units that may support a reduction operation according to some embodiments of the present invention.

FIG. 4 is a diagram illustrating a program unit being translated into a second program unit according to some embodiments of the present invention.

FIG. 5 is a diagram illustrating a portion of a first program being translated into a portion of a second program unit according to some embodiments of the present invention.

FIG. 6 illustrates a portion of a run-time reduction program according to some embodiments of the present invention.

FIG. 7 is a diagram of a reduction process implemented by a reduction program of FIG. 6 according to some embodiments of the present invention.

FIG. 8 illustrates an initial program unit according to some embodiments of the present invention.

FIG. 9 illustrates a first program unit translation of the initial program of FIG. 8 according to some embodiments of the present invention.

FIG. 10 illustrates two partial translations of the first program of FIG. 9 according to some embodiments of the present invention.

### DETAILED DESCRIPTION

In the following description, numerous specific details are set forth to provide a detailed understanding of the present invention. However, one skilled in the art will readily appreciate that the present invention may be practiced without these specific details. For example, the described code segments may be consistent with versions of the Fortran programming language. This however is by way of example and not by way of limitation as other programming languages and structures may be similarly utilized.

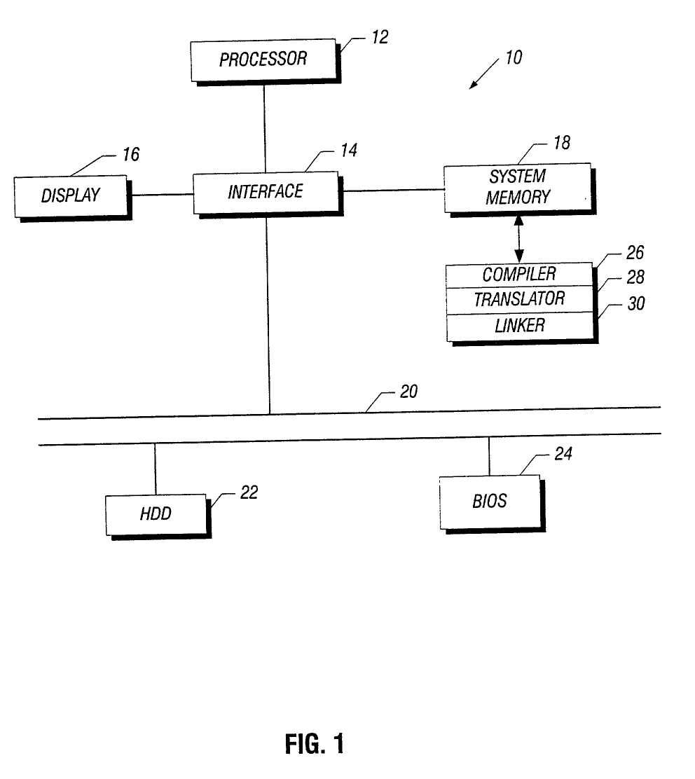

Referring to FIG. 1, a processor-based system 10 may include a processor 12 coupled to an interface 14. The interface 14, which may be a bridge, may be coupled to a display 16 or a display controller (not shown) and a system memory 18. The interface 14 may also be coupled to one or more busses 20. The bus 20, in turn, may be coupled to one or more storage devices 22, such as a hard disk drive (HDD). The hard disk drive 22 may store a variety of software, including source programming code (not shown), compiler 26, a translator 28, and a linker 30. A basic input/output system (BIOS) memory 24 may also be coupled to the bus 20 in one embodiment. Of course, a wide variety of other processor-based system architectures may be utilized.

In some embodiments, the compiler 26, translator 28 and linker 30 may be stored on hard disk 22 and may be subsequently loaded into system memory 18. The processor 12 may then execute instructions that cause the compiler 26, translator 28 and linker 30 to operate.

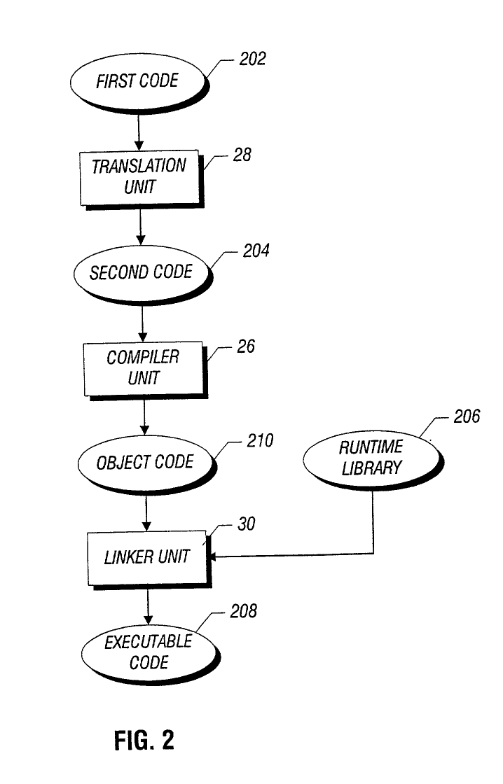

Referring now to FIG. 2, a first code 202 may be a source program that may be written in a programming language. A few examples of programming languages are Fortran 90, Fortran 95 and C++. The first code 202 may be a source program that may have been converted to parallel form by annotating a corresponding sequential computer programming with directives according to a parallelism specification such as OpenMP. In other embodiments, the first code 202 may be coded in parallel form in the first instance.

These annotations may designate, parallel regions of execution that may be executed by one or more threads, single regions that may be executed by a single thread, and instructions on how various program variables should be treated in the parallel and single regions. The parallelism specification in some embodiments, may include a set of directives such as the directive “!$omp reduce” which will be explained in more detail below.

In some embodiments, parallel regions may execute on different threads that run on different physical processors in the parallel computer system, with one thread per processor. However, in other embodiments, multiple threads may execute on a single processor.

In some embodiments, the first code 202 may be an annotated source code and may be read into a code translator 28. Translator 28 may perform a source-code-to-source-code level transformation of OpenMP parallelization directives in the first code 202 to generate, in some embodiments, Fortran 95 source code in the second code 204. However, as previously mentioned, other programming languages may be utilized. In addition, the translator 28 may perform a source-to-assembly code level or a source-to-intermediate level transformation of the first code 202.

The compiler 26 may receive the second code 204 and may generate an object code 210. In an embodiment, the compilation of translated first code 202 may be based on the OpenMP standard. The compiler 26 may be a different compiler for different operating systems and/or different hardware. In some embodiments, the compiler 26 may generate object code 210 that may be executed on Intel® processors.

Linker 30 may receive object code 210 and various routines and functions from a run-time library 206 and link them together to generate executable code 208.

In some embodiments, the run-time library 206 may contain function subroutines that the linker may include to support “!$omp reduce” directives.

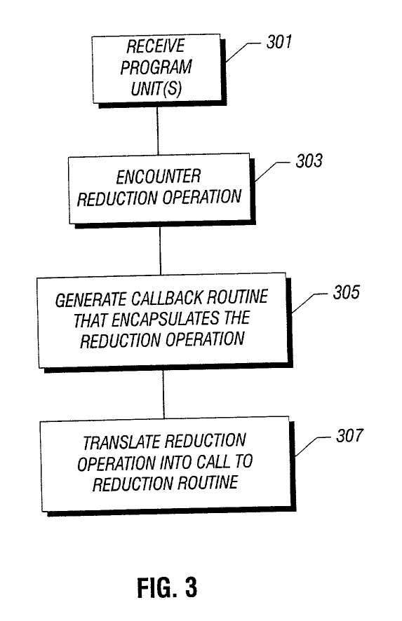

Referring to FIG. 3, the translator 28 may receive a program unit(s) 301. In some embodiments, a “program unit” may be a collection of statements in a programming language that may be processed by a compiler or translator. The program unit(s) 301 may contain a reduction operation 303. In response to the reduction operation 303, the translator 28, in some embodiments, may translate the program unit(s) 301 into a call to a reduction routine 307. In addition, the translator 30 may translate the program unit(s) 301 into a call to a reduction routine that may reference a generated callback routine 305.

The term “callback” is an arbitrary name to refer to the routine 305. Other references to the routine 305 may be utilized. The translation of program unit(s) 301 into the two routines 305 and 307 may be performed, in some embodiments, using a source-code-to-source-code translation. The source code may be Fortran 90, Fortran 95, C, C++, or other source code languages. However, routines 305 and 307 may also be intermediate code or other code.

The callback routine 305 may be a routine specific to the reduction to be performed. For example, the reduction may be an add, subtract, multiply, divide, trigonometric, bit manipulation, or other function. The callback routine encapsulates the reduction operation as will be described below.

The routine 307 may call a run-time library routine (not shown) that may utilize the callback routine 305 to, in part, perform a reduction operation. As part of the call to the run-time library routine, the routine 307 may reference the callback routine 305.

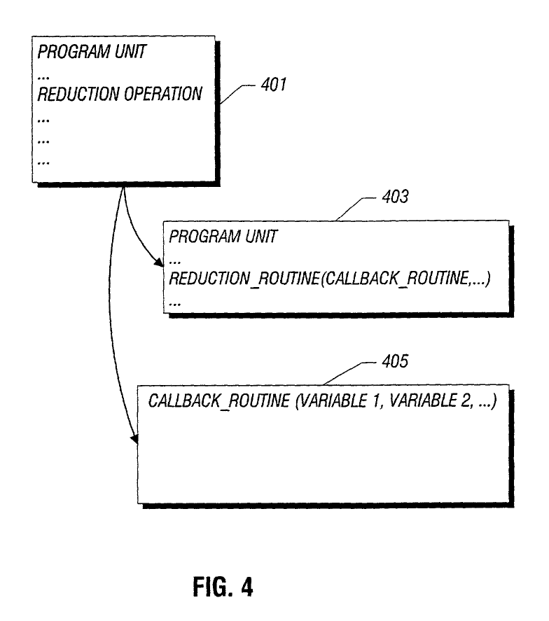

Referring to FIG. 4, a program unit 401 includes a reduction operation. Program units 403 and 405 are examples, in some embodiments, of routines 307 and 305 respectively that may be translated in response to the reduction operation in the program unit 401. An example of the reduction operation illustrated in the program unit 401 may have, in some embodiments, the following form:

!$omp reduce reduction (argument(s))

. . .

!$omp end reduce

The program unit 403 is an example of a translation of the program unit 401 in accordance with block 307 of FIG. 3. The reduction routine call in the program unit 403, in some embodiments, may have the following form:

Reduction_routine(callback_routine, variable1, . . . )

The program unit 405 is an example of a translation of the program unit 401 in accordance with block 305 of FIG. 3. This program unit 405 may contain source code, or other code, to perform an algebraic function to compute, in part, the reduction operation. For example, in some embodiments, to implement an addition reduction, the program unit 405 may contain the equivalent of the following code instructions:

Callback_routine(a0, a1)

a0=a0+a1

return

end

Where a0 and a1 may be variables that may be passed to the program unit 405. However, in other embodiments, in response to a reduction directive with a vector or array reduction argument, the program unit 405 may perform vector or array reductions. A vector or array reduction may, in some embodiments, be implemented, in part, by a 1 or more dimension loop nest that performs the vector or array reduction operations.

Also, multiple reduction operations may be combined, in some embodiments, so that a single reduction routine call may be utilized and a single callback routine may contain the code to perform the multiple reductions. By performing multiple reduction operations, an increase in performance and scalability of reductions operations may be realized as the associated processing and synchronization overhead may be reduced relative to performing separate reduction operations.

Additionally, in some embodiments, a reduction on objects may be achieved. The objects may be referenced by descriptors and the address of the descriptors may be passed through the reduction routine call and into the callback routine, in some embodiments. A descriptor may include an address of the start of an object and may include data describing the size, type or other attributes of the object.

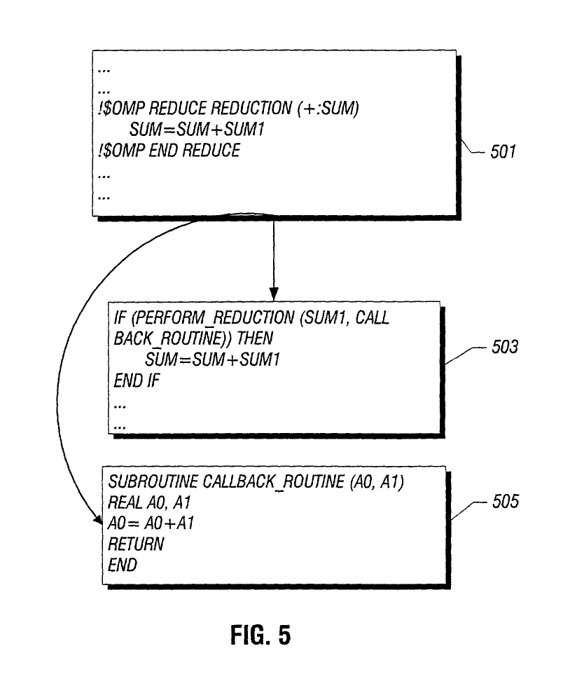

Referring to FIG. 5, the instructions and directives in block 501 may represent a program segment of a program unit to be translated. These instructions and directives, block 501, may be within a parallel construct, for example, a !$omp parallel/!$omp end parallel construct (not shown).

As described above with reference to elements 403 and 405, in like manner, the program segment 503 and callback routine 505 may be translations of the program segment 501, in some embodiments and may be executed by parallel threads forked (started) at some prior point in the program (not shown). The callback routine 505, in some embodiments, encapsulates the arithmetic operation to be performed by the reduction (i.e., summation, on “real” variables, in the illustrated example).

This encapsulation may be implemented, in some embodiments, so that the run-time library implementation of “perform_reduction( )” may be independent of the particular arithmetic operation for which the directive “!$omp reduce” may be used.

In some embodiments, the callback_routine( ), 505, takes the sum1 variables (the partial sums for each processor/thread) and may perform a scalable reduction operation to combine the partial sums into a single final sum.

One of the parallel threads, a master thread, calling, in some embodiments, the function “perform reduction( )” may return “TRUE” and load the final sum value into the variable “sum” (the instruction sum=sum+sum1 in program segment 503). The other threads besides the master thread participate in the computation of the final sum by gathering partial sums and passing them on to their neighbor threads. For other than the master thread, the “perform_reduction( )”, in program segment 503, may return “FALSE”. In some embodiments, the “perform reduction( )” function may be a run-time library function call as described below.

Designating a thread as the master thread may be arbitrary. For example, the master thread may be thread 0 or it may be the first thread to start executing the “If” statement in program segment 503. Of course, other methods of selecting the master thread may be utilized.

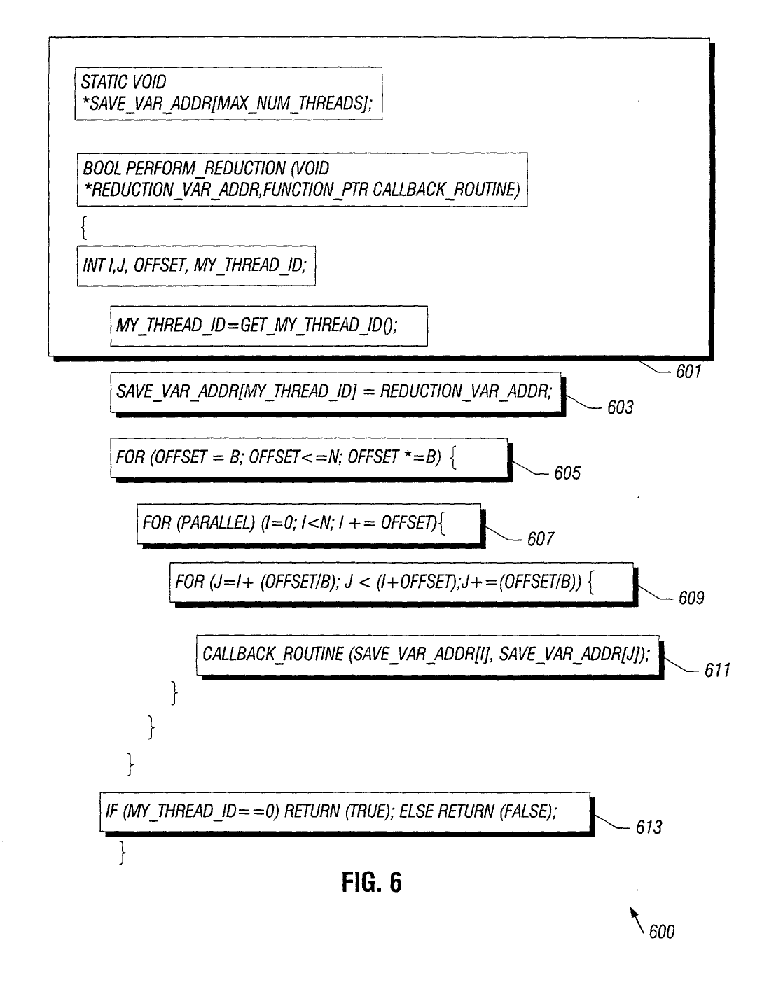

Referring to FIG. 6, 600 is a routine that may be a “perform_reduction( )” run-time library routine that, in part, performs a logarithmic reduction operation according to some embodiments of the invention. The function name “perform_reduction” may be arbitrary and other names may be utilized.

In one example, if the number of parallel threads is 8 (N=8) and B=2 (indicating the base of the logarithmic reduction), the partial sums may be computed in groups of 2 (i.e., pairwise). The perform_reduction routine may then operate as follows:

Each thread executing program segment 503 may call perform_reduction( ) in parallel, and each thread may pass the address of its own private “sum1” variable and a pointer to the callback_routine( ) that may, in some embodiments, perform the summation operations. In the routine of FIG. 6, each thread my be identified by the variable “my_thread_id” that, with eight parallel threads, may have the values of 0, 1, 2, 3, 4, 5, 6, or 7. Each thread my also perform certain initialization functions such as instructions 601 in some embodiments.

Each thread may save the address of its private “sum1” variable in save_var_addr[my_thread_id] so that other threads may see it, 603. So, save_var_addr[0] may refer to the private “sum1” variable for thread 0, save_var_addr[1] may refer to the private “sum1” variable for thread 1, etc.

A “for (offset=B)” loop, 605, may define one or more “stages” of the reduction operation. In each stage, threads may combine their partial sums with their neighboring threads (B at a time; since B=2 this may mean pairwise). Within each stage these combining operations may be done in parallel. The for (i) and for (j) loops, 607, and 609 respectively, tell which threads are combining their values, 611, with other threads during each stage. That is, i and j may be values of my_thread_id.

The “if” statement, 613, may identify the master thread, thread 0 in this example, that may perform the “sum=sum+1” instruction in program segment 503. In some embodiments, the “if” statement may return “True” if the executing thread is thread 0.

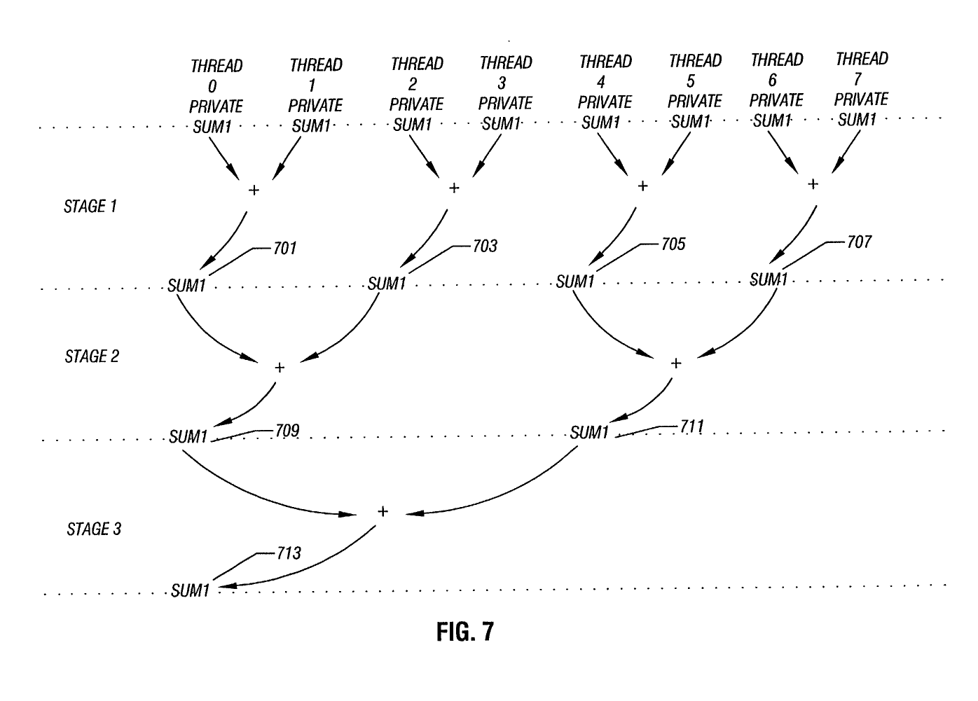

With reference to FIG. 7, a stage-by-stage detailed explanation of the routine of FIG. 6 may be as follows:

1. Threads my_thread id=0, 1, 2, 3, 4, 5, 6, 7 all call perform_reduction( ) in parallel (i.e., at the same time) from program segment 503 in some embodiments.

2. The first stage for offset=2 starts, 605. The following actions, in some embodiments, may occur, in parallel, during this first stage, by the specified threads:

a. thread 0: callback_routine (save_var_addr[0], save_var_addr[1]);

b. thread 2: callback_routine (save_var_addr[2], save_var_addr[3]);

c. thread 4: callback_routine (save_var_addr[4], save_var_addr[5]);

d. thread 6: callback_routine (save_var_addr[6], save_var_addr[7]);

3. At the end of the first stage, these variables may contain the following values:

a. private sum1 for thread 0 may contain thread 0+thread 1 sum1 values, 701.

b. similarly, thread 2 may contain thread 2+thread 3 values, 703.

c. thread 4 may contain thread 4+thread 5 values, 705.

d. thread 6 may contain thread 6+thread 7 values, 707.

4. The second stage with for offset=4 starts, 605. The following actions may occur, in parallel, during this second stage, by the specified threads:

a. thread 0: callback_routine (save_var_addr[0], save_var_addr[2]);

b. thread 4: callback_routine (save_var_addr[4], save_var_addr[6]);

5. At the end of the second stage, in some embodiments:

a. private sum1 for thread 0 may contain thread 0+thread 1+thread 2+thread 3 sum1 values, 709.

b. thread 4 may contain thread 4+thread 5+thread 6+thread 7 values, 711.

6. The third/last stage with for offset=8 starts, 605. The following actions may occur during this last stage by the specified thread, in some embodiments:

a. thread 0: callback_routine (save_var_addr[0], save_var_addr[4]);

7. In some embodiments, after the last stage, the private sum1 value for thread 0 may contain the thread 0+thread 1+thread 2+thread 3+thread 4+thread 5+thread 6+thread 7 values, 713.

8. Thread 0's invocation of perform_reduction( ), in program segment 503, may return TRUE, 613, and thread 0 sum1 variable may contain the final result; the rest of the threads may return FALSE.

9. In the calling code, program segment 503, thread 0's perform_reduction( ) operation returns TRUE, and the sum1 variable with the final sum is loaded into the “sum” variable, (the instruction sum=sum+sum1 in program segment 503) completing the reduction operation.

While a logarithmic reduction routine such as illustrated in FIG. 6 may be advantageous, other reduction algorithms may also be utilized. For example, in some embodiments, a logarithmic reduction algorithm utilizing a different base (B) may be implemented. Using a base (B)>2 may reduce the reduction time by reducing the number of stages that must be performed. As one example, a logarithmic reduction algorithm utilizing a base of B=4 may be implemented. In other embodiments, a linear reduction algorithm or other algorithm may also be utilized. Also, while the routine in FIG. 6 may be a run-time library, it is not so limited. For example, the routine may be implemented with in-line code or other constructs.

Embodiments of the invention may provide efficient, scalable, “!$omp reduce” operations. A single instantiation of the present embodiments of the invention may implement efficient reduction operations across multiple platforms (i.e., variants of hardware architecture, operating system, threading environment, compilers and programming tools, utility software, etc.).

In some embodiments, source-code-to-source-code translators may provide, in part, source-code translations while run-time library routines my be implemented using low-level instruction sets to support reduction operations on an individual platform in order to optimize performance on that platform. Such a combination of source-code translations and run-time library implementations, may, in some embodiments, provide a cost effective solution to optimize reduction operations on a plurality of computing platforms.

For example, in some embodiments, a run-time library routine, that-may perform a logarithmic reduction, may be optimized for a particular computer platform to partition the reduction operation between a plurality of threads. As previously described, partitioning the reduction operation such that each parallel thread may act to reduce a unique portion of the variables and then combining the reductions made by each parallel thread may increase the efficiency of the reduction operation, in some embodiments.

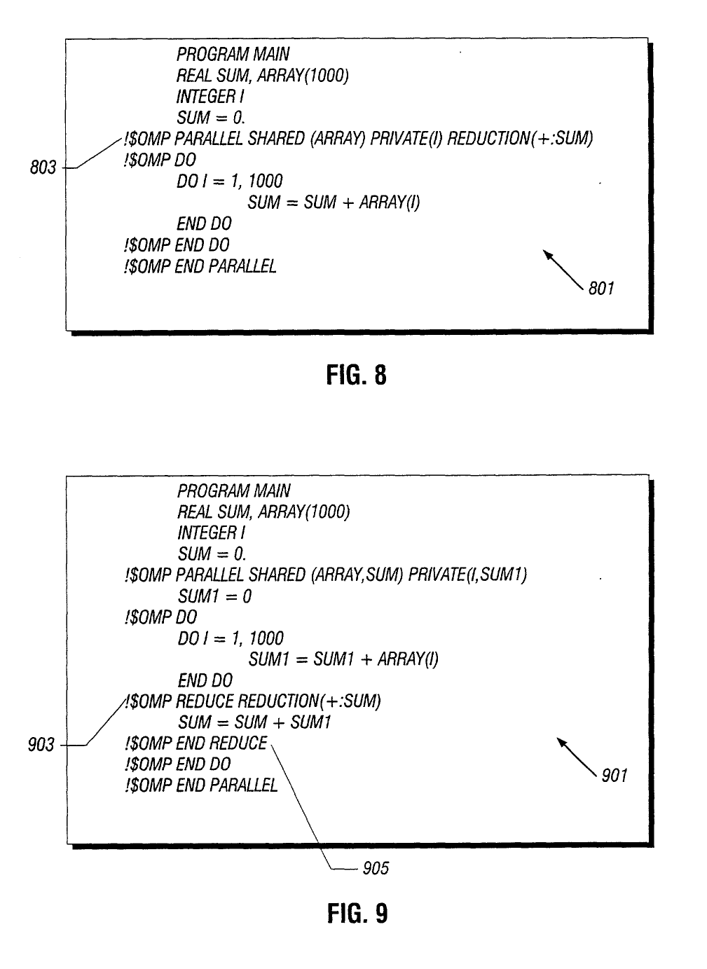

Other embodiments are also possible. For example, to generate a first code 202, the translator 28 or other translator may translate an initial code into the first code 202. Referring to FIG. 8, in one embodiment, an initial code 801 may include a reduction instruction 803. This initial code 801 may, in some embodiments, be translated by translator 28 into a first code 901 (FIG. 9) that may include a “!$omp reduce” construct 903-905.

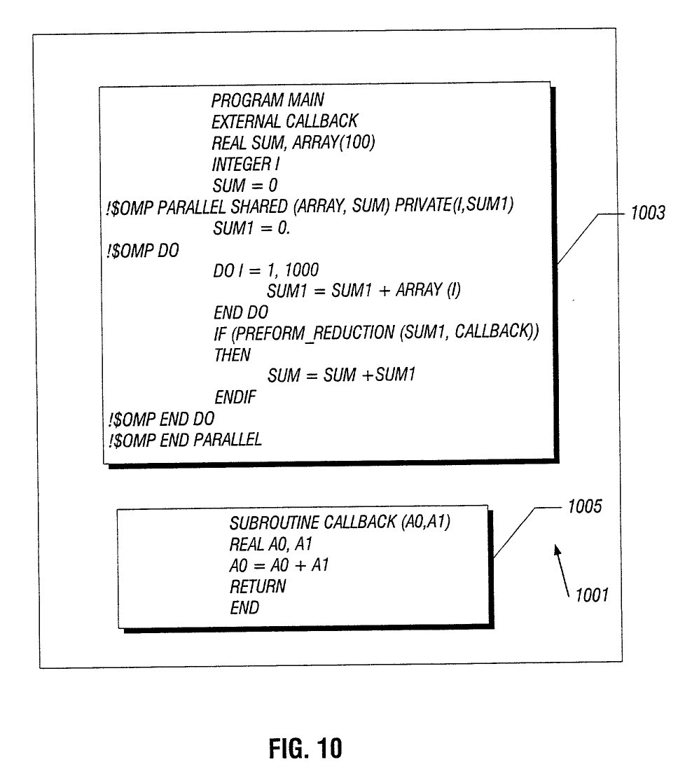

The first code 901 may represent an efficient intermediate translation of the initial code 801. The intermediate translation may then be further translated, in some embodiments, as described in association with FIG. 10.

Referring now to FIG. 10, the first code 901 may then, in some embodiments, be translated into a second code 1001 that includes a program segment 1003 and a callback routine 1005. The operation of the program segment 1003 and the callback routing 1005 may be generally as described above in association with the program segment 503 and the callback routine 505.

In other embodiments, the translator 28 may translate other code constructs into a different form. For example, in some embodiments, the translator 28 may translate an initial code or first code, as two examples, that includes the instructions “!omp critical” and “!$omp end critical” into “!omp reduce” and “!omp end reduce” respectively. As one illustrative example, in some embodiments, the translator 28 may replace the code construct:

!$OMP critical(+:SUM)

sum=sum+sum1

!$OMP end critical

With the construct 903-905, in FIG. 9, and then may be further translated, in some embodiments, as discussed above in association with FIG. 10. The translation of the “critical” construct into the construct 903-905 may allow a program that may be a legacy program utilizing the “critical” instructions, to be translated without having to manually modify “critical” instruction in the legacy code.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a first program unit in a parallel computing environment, the first program unit including a reduction operation associated with a set of variables;
translating the first program unit into a second program unit, the second program unit to associate the reduction operation with a set of one or more instructions operative to partition the reduction operation between a plurality of threads including at least two threads; and
translating the first program unit into a third program unit, the third program unit to associate the. reduction operation with a set of one or more instructions operative to perform an algebraic operation on the variables.

2. The method of claim 1 further comprising encapsulating the reduction operation with the instructions associated with the third program unit.

3. The method of claim 1 further comprising reducing the variables logarithmically.

4. The method of claim 1 further comprising translating the first program unit into the second program unit utilizing, in part, a source-code to source-code translator.

5. The method of claim 1 further comprising translating the first program unit into the third program unit utilizing, in part, a source-code to source-code translator.

6. The method of claim 1 further comprising associating the plurality of threads each with a unique portion of the set of variables.

7. The method of claim 6 further comprising combining, in part, the variables associated with the plurality of threads in a pair-wise reduction operation.

8. An apparatus comprising:
a memory including a shared memory location;
a translation unit coupled with the memory, the translation unit to translate a first program unit including a reduction operation associated with a set of at least two variables into a second program unit, the second program unit to associate the reduction operation with one or more instructions operative to partition the reduction operation between a plurality of threads including at least two threads;
a compiler unit coupled with the translation unit and the shared-memory, the compiler unit to compile the second program unit; and
a linker unit coupled with the compiler unit and the shared-memory, the linker unit to link the compiled second program with a library.

9. The apparatus of claim 8 wherein the second program unit associates a set of one or more instructions with the reduction operative to encapsulate the reduction operation.

10. The apparatus of claim 8 wherein the variables in the set of variables are each uniquely associated with the plurality of threads and the library includes instructions operative to combine, in part, the variables associated with the plurality of threads.

11. The apparatus of claim 10 wherein the library includes instructions operative to combine, in part, the variables in a pair-wise reduction.

12. The apparatus of claim 8 further comprising a set of one or more processors to host the plurality of threads, the plurality of threads to execute instructions associated with the second program unit.

13. The apparatus of claim 8 wherein the second program includes a callback routine and the callback routine is associated with instructions operative to perform an algebraic operation on at least two variables in the set of variables.

14. The apparatus of claim 13 wherein the library is operative to call the callback routine to perform, in part, a reduction on at least two variables in the set of variables.

15. A machine-readable medium that provides instructions, that when executed by a set of one or more processors, enable the set of processors to perform operations comprising:
receiving a first program unit in a parallel computing environment, the first program unit including a reduction operation associated with a set of variables;
translating the first program unit into a second program unit, the second program unit to associate the reduction operation with a set of one or more instructions operative to partition the reduction operation between a plurality of threads including at least two threads; and
translating the first program unit into a third program unit, the third program unit to associate the reduction operation with a set of one or more instructions operative to perform an algebraic operation on the variables.

16. The machine-readable medium of claim 15 further comprising encapsulating the reduction operation with a set of one or more instructions.

17. The machine-readable medium of claim 15 further comprising translating the first program unit into the second program unit utilizing, in part, a source-code to source-code translator.

18. The machine-readable medium of claim 15 further comprising reducing the variables, in part, logarithmically.

19. The machine-readable medium of claim 15 further comprising translating the first program unit into the third program unit utilizing, in part, a source-code to source-code translator.

20. The machine-readable medium of claim 15 further comprising the second program unit utilizing, in part, the third program unit to perform a reduction operation on the set of variables.
